(19) United States
(12) Patent Application Publication
(10) Pub. No.: US 2008/0146284 A1
(43) Pub. Date: Jun. 19, 2008

(54) Mini cell phone adapter and method for extending the function of a mini cell phone

(76) Inventors: Samuel W. Stone, Sylmar, CA (US); Dylan Evan Stone, Sylmar, CA (US); Samuel Lee Stone, Sylmar, CA (US)

Correspondence Address: CHRISTOPHER D. HARRINGTON;SUITE 350, 5300 CORPORATE GROVE DRIVE, SE, GRAND RAPIDS, MI, 49512, US

(21) Appl. No.: 11/640,519

(22) Filed: Dec. 18, 2006

(51) Int. Cl. H04M 1/00

(52) U.S. Cl. 455/565

(57) ABSTRACT

A new mini cell phone and adapter are disclosed where the mini cell phone is of the type that has restricted usage. The adapter is provided so that a user may selectively restore full functioning capability to the mini cell phone upon occasions. In addition, the adapter provides for the recharging of the battery of the mini cell phone portion that is integrated between the two components.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to mini cell phones, namely those types of cell phones that have limited or restricted functions. More particularly, the present invention relates to an adapter for selectively adding full f unction capability to a mini cell phone.

Mini cell phones as this term will be used throughout this specification, is a cell phone that has been modified to perform with less functions or that is restricted to perform less functions than a normal regularly functioning cell phone. The purpose of a mini cell phone is to typically provide a means for child or a teenager to have the ability to call emergency numbers or certain specified numbers, such as parents, and to prevent or block any other calls from originating from that phone. Many times the function of the phone is modified within its operating chip to block incoming calls as well except for certain specified numbers.

The benefits of the mini cell phone result both from the control over the phone calls that can be made thus avoiding excessive phone bills, but also from the safety and security in having one's son or daughter equipped with a cell phone that is still fully capable of sending a call to a an emergency number or to a parent or guardian. This limited use encourages the parent or guardian to consider the mini cell phone for use since the temptation for the son or daughter to overuse or abuse the phone is mooted.

Mini cell phones of various types are known in the prior art. For instance, in U.S. Pat. No. 5,365,570 (Boubelik) a restricted use cell phone is disclosed. In one embodiment, the cell phone is a fall function cell phone that has been modified with a cover plate to restrict access to the number keypad. In U.S. Pat. No. 6,115,597 (Kroll, et al) a disposable cell phone that is use-restricted to just emergency phone is disclosed. Although not as restricted, a special use cell phone in shown in U.S. Pat. No. 5,555,286 (Tendler) where it includes emergency and vehicle location capabilities.

A different approach is taken in U.S. Pat. No. 5,797,091 (Clise, et al) where a compact personal communication system is taught and includes GPS location capability, text messaging and other functions. A compact emergency use only cell phone is disclosed in U.S. Pat. No. 6,044,257 (Boling, et al) where the function of the phone is solely set for emergency communications.

Design for compact cell phones are known in the prior art as well and includes U.S. Design Pat. No. D503,699 (Lee, et al) which displays a compact cell phone which appears to be a full functioning unit. There are mini cell phones beyond the cell phones discussed above, that are known in the prior art as well including one that is marketed as the “Firefly” which can be seen displayed at www.fireflymobile.com. This version of a mini cell phone uses five buttons for navigation making it easy to use and also providing restrictions as to the outgoing phone calls that can be made. It is directed towards use by children and allow for parental management of their phone calls and their calling usage.

Notwithstanding the benefits and attributes of the foregoing prior art cell phones, there still remains a number of problems associated with mini cell phone and restricted cell phone products. One such problem is the mini cell phone itself which includes much of the hardware and software as would be included in a full feature cell phone but which remains restricted no matter what. While the restrictions are the initial objective, there may come certain times and/or events where the parents would elect to restore full feature access to the child or teenager. This could happen on vacation trips, or school outings, or other occasions where it may be desired to allow for cross talk between others who have cell phones. Another limitation is the inclusion of functions and features that are typically provided on the cell phone itself, such as LCD (liquid crystal display) display, integrated battery charger input, and enhanced function keys. The teachings of the prior art indicate that such functions are not included on the mini cell phone unit and would be sacrificed even if a mini cell phone unit were to suddenly have a fully restored functional ability. These and other deficiencies in the prior art will be discussed and compared with respect to the embodiments of the present invention as set forth herein.

### SUMMARY OF THE INVENTION

A novel mini cell phone in conjunction with the present invention, comprises a mini cell portion and an adapter portion where the mini cell portion is a restricted use cell phone that can be used independently. The adapter portion integrates with the mini cell phone and when the adapter portion is operationally connected to the mini cell portion full cell phone function capability is achieved, resulting in a full featured cell phone. In addition, the adapter portion includes an LCD display for providing information and for assistance in navigating through the operation steps involved in using the full featured cell phone.

In addition to the foregoing, the adapter portion also includes a power conduit for the purposes of integrating the recharging function between the adapter portion and the mini cell phone, without having to resort to duplicate charging units.

These and other attributes and features of the present invention will be disclosed in more detail below.

### BRIEF DESCRIPTION OF THE DRAWINGS

FIG. 1 is a front elevational view of a mini cell phone of the prior art.

FIG. 2 is a rear elevational view of the mini cell phone of FIG. 1.

FIG. 3 is a front elevational view of a mini cell phone and an adapter of the present invention as shown in the detached condition.

FIG. 4 is a front elevational view of the mini cell phone and adapter of FIG. 3 excepting the mini cell phone and the adapter are shown as being operationally connected.

FIG. 5 is a side view of the mini cell phone and adapter of FIG. 3.

FIG. 6 is a side view of the mini cell phone and adapter of FIG. 4.

FIG. 7 is an end view of the mini cell phone portion of the present invention showing the inputs for recharging and for the connection bus.

### DETAILED DESCRIPTION OF THE PREFERRED EMBODIMENTS

A mini cell phone and adapter in accordance with the present invention, is shown in the drawings and is discussed in detail within this specification. As mentioned above, mini cell phones and restricted use cell phones are known but both approaches to the types of usage of a cell phone represent compromises. For instance, in the case of the mini cell phone, it includes virtually all of the hardware and software needed for full function operation but could not perform the full functions as configured. This actually increases the costs to the consumer since they will have to purchase a second cell phone in order to acquire a full functioning unit. In some cases a conventional cell phone is restricted by alteration of the hardware or through the alteration of the software. Sometimes these alterations are permanent and cannot be reversed to provide full functioning operation. In some cases the alterations can be reversed, although the utility of a mini cell phone in having a small size that is easier for a child to carry is lost by virtue of having to carry around a complete unit at all times.

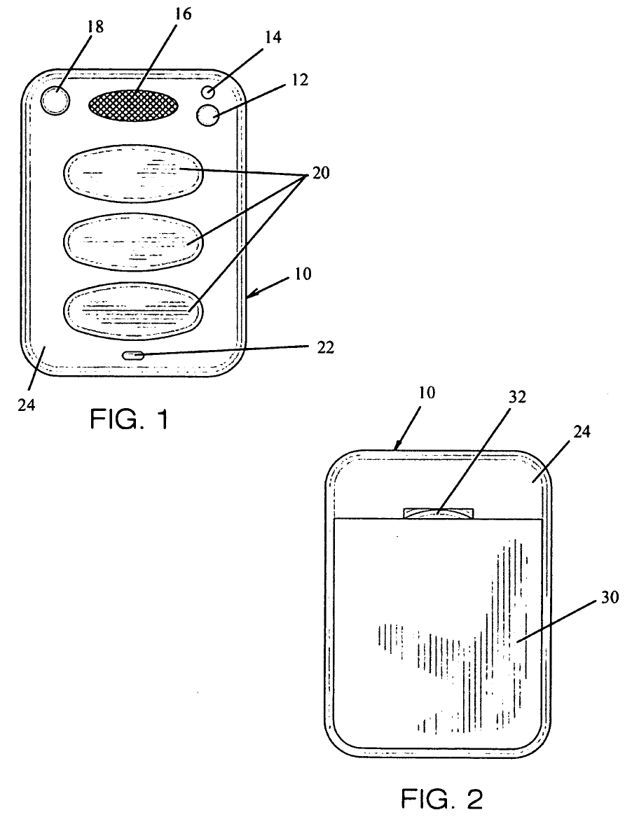

The present invention provides a solution to many of the deficits associated with the prior art mini cell phones and restricted cell phones. This may be understood now by referring to the drawings. In FIGS. 1 and 2, a mini cell phone 10 of a conventional type and design is shown with an on/off switch 12, an LED indicator 14, a speaker 16, an answer/call button 18, pre-set call buttons 20, a microphone 22 and the case 24. The back side of the mini cell phone 10 is shown in FIG. 2 and includes the access panel 30 and the snap lock 32.

In use, the mini cell phone 10 is typically programmed with a few parental-approved telephone numbers. These will typically include an emergency number, the numbers for either one or both of the parents, and any other phone number that the parents may deem appropriate or necessary. Each pre-programmed number is activated by pressing one of the pre-set call buttons. The mini cell phone may be powered by a disposable battery or a rechargeable battery which is accessed through the access panel on the back side of the mini cell phone. In the conventional type of mini cell phone, the size of the unit is small enough to be carried by children in their pants pockets, or in backpacks, or a trapper-keeper. The mini cell phone may be easily turned off since in many situations the child is confronting, such as the classroom or a movie theatre or the like, the usage of cell phones is disallowed. The deployment of a face-mounted on/off switch allows the mini cell phone to be turned on easily when needed and deactivated when needed.

The advantages of the typical mini cell phone, as mentioned above, include the parental control that can be asserted on the types of phone calls that a child can make and receive. Cell phones are enabled with microprocessors that use software to manage the operations. The software, in the case of the mini cell phone, is able to take instructions regarding the numbers that are authorized both for transmission and for receipt. In essence, the mini cell phone is capable of full functions but is purposefully restricted both by software and the architecture of unit in accordance with the objectives outlined above.

With all of the advantages of the mini cell phone, it still represents a compromise in terms of economy and utility. The usage of the mini cell phone may not be required at all times when a parent is empowering their child with cell phone communications. There are certainly times when it would be desired to have full functioning capability in a cell phone, whether this occurs because the parent desires to use the unit or whether it is because there is a conscious need on the part of the parent to provide full functioning capability to the child. It is a matter of discretion on the part of the parent who may be making these decisions many times in a given week. Therefore the use of a mini cell phone that is dedicated to something less than full functioning capability eliminates this ability of a parent to make such decisions. A similar situation also occurs with respect to the restricted use cell phones, especially where the cell phone has a shield that is used to mask out access to the full functioning portions of the cell phone operations. To be effective, the means by which the restrictions are imposed on the cell phone have to be robust enough to prevent the child from circumventing. This may require special fittings that can be opened using special tools or other methods that resist tampering. Thus, even though the restricted use phones may carry full functioning capability, these cell phones are a nuisance when it comes to quickly responding to the election on the part of a parent to select full or restricted uses.

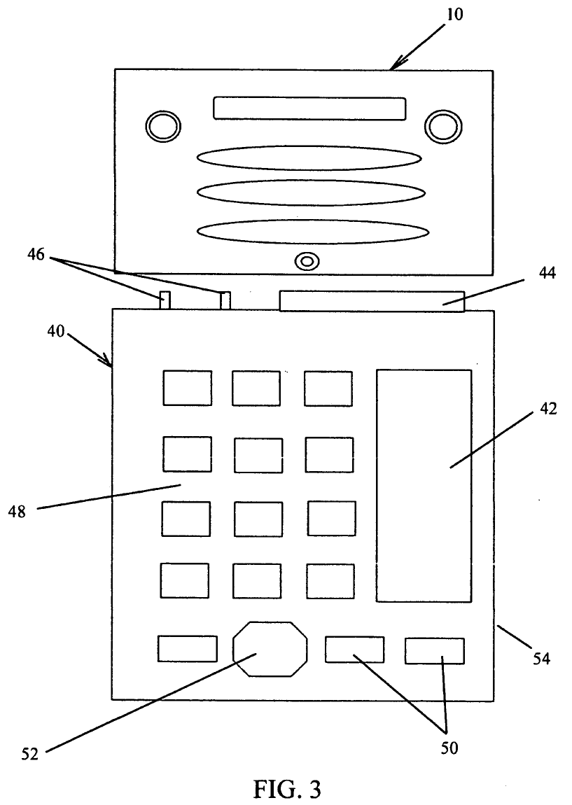

Turning now to the preferred embodiment of the present invention, FIG. 3 displays two components, the mini cell phone 10 portion and the function module portion 40. As will be seen below, the function module 40 acts like an adapter in terms of changing the capability of the mini cell phone module 10 thus the terminology “adapter” applies. The mini cell phone portion 10 resembles in appearance and in function the typical mini cell phone as described above. As shown in FIG. 3, the mini cell phone portion 10 is not connected to the function module 40, although it is oriented in a position where the two components can be operationally connected.

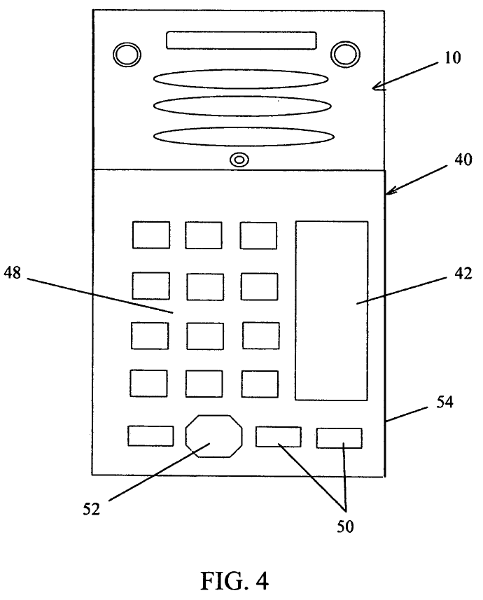

The function module 40 includes the LCD display 42, the function bus 44, the power plug 46, the key pad 48, the function buttons 50, the scroll/tab button 52 and the case 54. In FIG. 4, the mini cell phone portion 10 is shown as being operationally engaged with the function module 40.

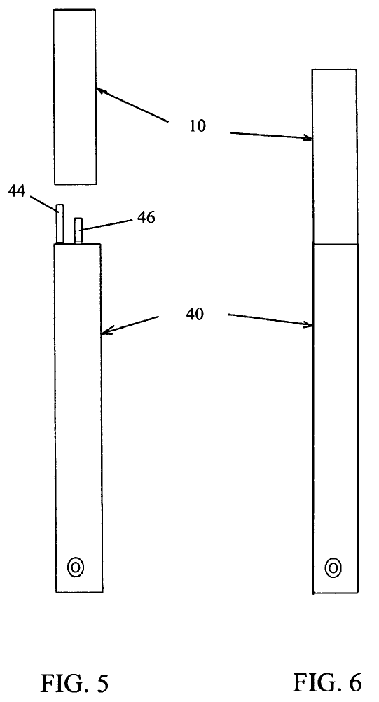

Turning now to FIGS. 5 and 6, the side view of the mini cell phone portion 10 and the function module 40 are shown in their disengaged and engaged conditions with respect to the corresponding views shown in FIGS. 3 and 4. In addition, the charger input 60 can be viewed.

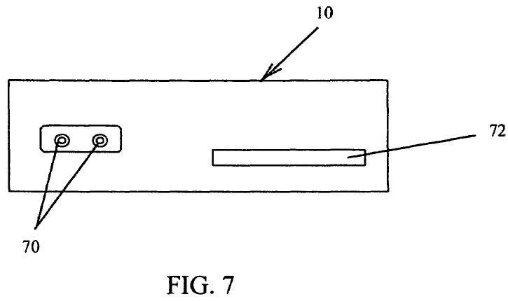

Lastly, in FIG. 7, the mini cell phone portion 10 is shown as viewed from the end that engages the function module 40. As can be seen, the power plug inputs 70 and the function bus input 72 are recessed into the body of the mini cell phone portion 10 and are aligned for engagement with the counterpart power plug 46 and the function bus 50.

The function module contains the elements of a full functioning cell phone that are missing from the mini cell phone portion. By engaging the two components together, the keypad, function buttons and the scroll/tab button are operational and allow the user to access all of the cell phone capabilities that reside in the cell phone microprocessor. As explained above, the mini cell phone contains the microprocessor and is fully functional except for the hardware or architectural limitations. Once the function module is added to the mini cell phone portion, full functionality is restored.

In addition, the function module can also act as a conduit for recharging the mini cell phone portion. In the prior art mini cell phones, each mini cell phone either relied upon a rechargeable battery or a replaceable battery for power. Adding another powered module to such a mini cell phone would duplicate power sources and would needlessly add to the cost of producing the present invention if dual power sources were retained. Instead, the mini cell phone and adapter of the present invention allows the user to use one charging system to charge the battery source in the mini cell phone portion through the use of the charger input which is directly connected to the power plug. The charging system can either be plugged into an appropriate input for the function module or one could be retained on the mini cell phone portion. When the power plug is engaged with the mini cell phone portion, a connection is made to the battery pack in the mini cell phone to allow it to be charged from the function module if this is desired. Once the charging system is removed from the charge input, the battery for the mini cell phone portion can supply power (to the extent it is needed) to the function module. If the function module is disengaged from the mini cell phone portion, then the battery connection is broken to the function module as well, however, the mini cell phone remains powered.

The actual connections and location of the battery, the charging components and wiring are left to one skilled in the art as the usage of a charger to supply power to a battery supply for a hand held device is well known in the art and does not specifically comprise a part of the present invention. The scheme disclosed herein, by which the mini cell phone portion retains the power supply for use while it is engaged with the function module and also when it is disengaged from the function module is a part of the present invention. It is also noted that the mini cell phone portion may retain replaceable batteries. This would be useful where the child is given the mini cell phone to use on a trip and would otherwise be remote from the function module and the ability to recharge the unit. In such a case, the function module may carry the rechargeable battery source within its case and this would be used to power the combined and engaged mini cell phone portion and the function module, thus avoiding draining the replaceable battery source in the mini cell phone portion.

As may now be appreciated, the mini cell phone and adapter of the present invention posses increased utility over those variations on cell phones known in the prior art. The ability to alter the functionality at the discretion of the user is important for parents who are making decisions about how much cell phone capabilities their child's needs. In addition, the parent may desire to use the same cell phone and would therefore want to have full functioning capability and this can be achieved with the present invention without resort to laborious efforts to free up restricting devices. The parent can have the best of worlds, a special use mini cell phone and a fully functioning cell phone, at the sole discretion of the user and without having to invest in two separate systems.

The mini cell phone and adapter of the present may be configured in any number of ways. The case can be provided with different colors and made to coordinate with other devices. Inasmuch as the mini cell phone portion is directed for use by children, this unit can be made in different “kid friendly” shapes and design as well. This could include offerings where the case is shaped to resemble a cartoon character or the case carries graphics that relate to popular shows, movies, characters and the like.

The present invention may also be adapted for use with more than one mini cell phone portion. For instance, one function module could be provided that would work with any one of a plurality of mini cell phone portions. This would increase the flexibility of use of the mini cell phones and the function module. The ability to purchase one function module would allow the owner to apply it to a number of different mini cell phones without having to purchase a function module that is specific for each, or having to purchase a new function module every time a phone plan is changed and new mini cell phones would be required.

The mini cell phone portion and the function module of the present invention may be deployed pursuant to a method. The mini cell phone, being capable of performing independent from the function module can be used in that manner and with the restrictions that are place upon the mini cell phone usage. The mini cell phone may be restored to full functioning however by connected the mini cell phone portion with the function module through the engagement of the power plug and the function bus of the function module with the corresponding inputs in the mini cell phone portion. Usage of the mini cell phone would then become unrestricted. In addition, the power supply for the mini cell phone could be recharged through the integrated charging system of the function module. When full functioning is no longer desired, the user then disengages the mini cell phone portion from the function module.

The illustration and teachings herein are meant to disclose the ways in which the present invention may be used and it is not the intention to limit the scope of the invention in anyway. Other variations and modifications may be made to the mini cell phone and adapter of the present invention without departing from the spirit and scope of the teachings herein.

We claim:

1. A mini cell phone for use as a cell phone with restricted capabilities, and an adapter for same for use in the restoration of full function to the mini cell phone, the mini cell phone and adapter comprising:
A mini cell phone portion; and,
A function module including a keypad, where the function module is reversibly engageable with the mini cell phone portion to provide full functioning capability to the mini cell phone portion when the function module and the mini cell phone portion are engaged, and where the mini cell phone portion is returned to restricted operation when the function module and the mini cell phone portion are disengaged.

2. The mini cell phone and adapter of claim Number 1, where the function module also include function buttons.

3. The mini cell phone and adapter of claim Number 2, where the function module further includes a scroll/tab button.

4. The mini cell phone and adapter of claim Number 1, where the mini cell phone portion is powered by replaceable batteries and where the function module includes a rechargeable battery source, and where the power supplies for function module and the mini cell phone portion are integrated operationally where the rechargeable battery source powers the full functioning combination of the mini cell phone portion and the function module when they are in the engaged condition, and the replaceable battery source powers the mini cell phone portion when it is in the disengaged condition.

5. The mini cell phone and adapter of claim Number 1, where the mini cell phone includes pre-set call buttons.

6. A mini cell phone for use as a cell phone with restricted capabilities, and an adapter for same for use in the restoration of full function to the mini cell phone, the mini cell phone and adapter comprising:
A mini cell phone portion comprising a case, a speaker, a microphone, a battery power source, and a number of pre-set call buttons;
A function module including a keypad, where the function module is reversibly engageable with the mini cell phone portion to provide full functioning capability to the mini cell phone portion when the function module and the mini cell phone portion are engaged, and where the mini cell phone portion is returned to restricted operation when the function module and the mini cell phone portion are disengaged.

7. The mini cell phone and adapter of claim Number 6, where the mini cell phone portion is powered by replaceable batteries and where the function module includes a rechargeable battery source, and where the power supplies for function module and the mini cell phone portion are integrated operationally where the rechargeable battery source powers the full functioning combination of the mini cell phone portion and the function module when they are in the engaged condition, and the replaceable battery source powers the mini cell phone portion when it is in the disengaged condition.

8. The mini cell phone and adapter of claim Number 6, where the function module also include function buttons.

9. The mini cell phone and adapter of claim Number 8, where the function module further includes a scroll/tab button.

10. The mini cell phone and adapter of claim Number 6, where the case of the mini cell phone may be comprised of an ornamental appearance designed to appeal to a child.

11. A method for the use of a mini cell phone that includes an adapter for the mini cell phone where the adapter is reversibly engageable with the mini cell phone to provide full functioning capability to the mini cell phone when the adapter and the mini cell phone are engaged, and where the mini cell phone is returned to restricted operation when the adapter and the mini cell phone are disengaged, the steps comprising:
Providing a power supply for the mini cell phone;
Powering the mini cell phone;
Selecting to use the mini cell phone in a restricted mode or in a full functioning mode of operation, where upon selecting the full functioning mode of operation the adapter is connected and operationally engaged with the mini cell phone;

12. The method for the use of a mini cell phone and adapter of claim Number 11, where the power supply for the mini cell phone is a battery source.

13. The method for the use of a mini cell phone and adapter of claim Number 12, the additional step including:
Recharging the battery power supply.

14. The method for the use of a mini cell phone and adapter of claim Number 11, where the mini cell phone has a replaceable battery source and where the adapter includes a rechargeable battery source.
